(19) United States
(12) Patent Application Publication
(10) Pub. No.: US 2012/0172039 A1
(43) Pub. Date: Jul. 5, 2012

(54) SYSTEM AND METHOD FOR SECURING LOST TERMINAL USING WIRELESS NETWORK

(75) Inventors: Soo Eun KO, Gunpo-si (KR); Nak Jin KIM, Seoul (KR); Myong Ju KIM, Seoul (KR); Yong Pyo LEE, Seoul (KR); In Ho LEE, Seoul (KR); Jong Hwan LEE, Seoul (KR); Ho Jeong JEONG, Ansan-si (KR)

(73) Assignee: Pantech Co., Ltd., Seoul (KR)

(21) Appl. No.: 13/224,122

(22) Filed: Sep. 1, 2011

(30) Foreign Application Priority Data
Dec. 30, 2010 (KR) 10-2010-0139165

(51) Int. Cl. H04W 60/00

(52) U.S. Cl. 455/435.1

(57) ABSTRACT

A system and method for securing a lost terminal using a wireless network are provided. The system includes a lost terminal registration server to store unique terminal information of a lost terminal, and a terminal including a wireless Local Area Network (LAN) module to connect to the lost terminal registration server to determine whether the terminal is registered as a lost terminal in the lost terminal registration server. If the terminal is determined to be a lost terminal, then the lost terminal may be tracked and/or locked to secure the terminal.

### CROSS-REFERENCE TO RELATED APPLICATION

This application claims priority from and the benefit under 35 U.S.C. §119(a) of Korean Patent Application No. 10-2010-0139165, filed on Dec. 30, 2010, which is incorporated by reference for all purposes as if fully set forth herein.

### BACKGROUND

1. Field

This disclosure relates to a system and a method for securing a lost terminal using a wireless network.

2. Discussion of the Background

Conventionally, when a terminal is lost, the owner of the lost terminal may register the lost terminal through a communication service provider to recover the lost terminal. The communication service provider network, to which the lost terminal is registered, may then track the lost terminal to enable the owner of the lost terminal to recover the lost terminal.

In order to track the lost terminal through the communication service provider network as described above, a subscriber authentication module, such as Subscriber Identity Module (SIM) or User Services Identity Module (USIM), may have to be or remain mounted or installed in the lost terminal.

However, if the subscriber authentication module is not mounted or installed in the lost terminal, the lost terminal may be unable to be tracked through the communication service provider network.

With the development of the communication technology, various operations, such as a digital camera operation, a multimedia recording/play operation, a Digital Multimedia Broadcasting (DMB) operation, a payment operation, a wireless Internet operation, an electronic organizer operation and a game operation, may be provided in a terminal. Many of these operations can be used in a state where the subscriber authentication module may be absent in the terminal.

Particularly, in the case of a terminal having a wireless Local Area Network (LAN) module, wireless Internet services may be provided through a wireless network, and not through the communication service provider network. Therefore, even in the state where the subscriber authentication module may be absent in the terminal, various application programs can be downloaded through the wireless Internet for use.

Accordingly, in a case where a person, who comes across a lost terminal to possess the lost terminal (“finder”), removes the subscriber authentication module belonging to is the original owner and uses it for himself/herself without installing a subscriber authentication module of his/her own in the lost terminal, the lost terminal may not be tracked.

### SUMMARY

Exemplary embodiments of the present invention provide a system and a method for confirming a lost terminal using a wireless network.

Additional features of the invention will be set forth in the description which follows, and in part will be apparent from the description, or may be learned by practice of the invention.

Exemplary embodiments of the present invention provide a system to secure a lost terminal using a wireless network including a lost terminal registration server to store unique terminal information of a lost terminal; and a terminal including a wireless LAN module to execute the wireless LAN module, to connect to the lost terminal registration server using the wireless network, and to determine whether the terminal is registered as a lost terminal in the lost terminal registration server.

Exemplary embodiments of the present invention provide a terminal including a wireless LAN module to transmit and receive a signal to and from a wireless network; and a control unit to execute the wireless LAN module to connect to a lost terminal registration server using the wireless network, and to determine whether the terminal is registered as a lost terminal in the lost terminal registration server.

Exemplary embodiments of the present invention provide a method for securing a lost terminal using a wireless network, including attempting to connect to a wireless network by executing a wireless LAN module in a terminal; connecting to a lost terminal registration server using the connected wireless network; and determining whether the terminal is registered as a lost terminal in the lost terminal registration server.

It is to be understood that both foregoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram illustrating a system to secure a lost terminal using a wireless network according to an exemplary embodiment of the invention.

FIG. 2 is a schematic diagram illustrating a terminal to determine its lost status using a wireless network according to an exemplary embodiment of the invention.

FIG. 3 is a process diagram of a method for securing a lost terminal using a wireless network according to an exemplary embodiment of the invention.

### DETAILED DESCRIPTION OF THE ILLUSTRATED EMBODIMENTS

The invention is described more fully hereinafter with reference to the accompanying drawings, in which exemplary embodiments are shown. This invention may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Throughout the drawings and the detailed description, unless otherwise described, the same drawing reference numerals are understood to refer to the same elements, features, and structures. The relative size and depiction of these elements may be exaggerated for clarity, illustration, and convenience.

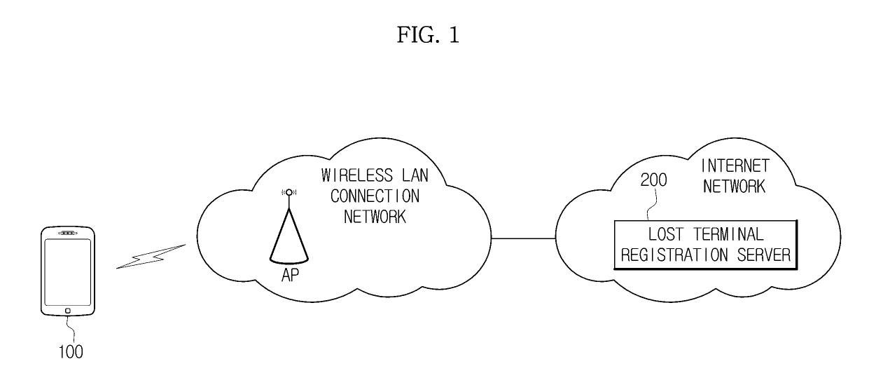

FIG. 1 is a schematic diagram illustrating a system to secure a lost terminal using a wireless network according to an exemplary embodiment of the invention.

Referring to FIG. 1, a terminal 100 has a wireless Local Area Network (LAN) module to connect to a wireless network, such as Wi-Fi, WiMAX®, Wireless Broadband (WiBro®), or the like. If the terminal 100 has completed booting up and a Subscriber Identity Module (SIM) or a User Services Identity Module (USIM) is absent from the terminal 100, the terminal 100 may execute the wireless LAN module to connect to the wireless network. Once connected to the wireless network, the terminal 100 may connect to a lost terminal registration server 200 to determine whether the terminal 100 is registered in the lost terminal registration server 200 as a lost terminal.

If the terminal 100 is determined to be a lost terminal, the terminal 100 may back up unique terminal information so that the terminal 100 may determine the unique terminal information using the backed-up data even if a finder arbitrarily changes the unique terminal information. In an example, the finder may refer to a person who may come into possession of the lost terminal without consent from the owner of the lost terminal. The unique terminal information, without limitation, may include International Mobile Equipment Identity (IMEI), Electronic Serial Number (ESN), Media Access Control (MAC) for the wireless network, a black box, and the like.

In addition, if the terminal 100 is determined to be a lost terminal, the terminal 100 may activate a locking operation to limit unauthorized access or illegal use of the lost terminal by the finder. In an example, once the locking operation is activated, the terminal 100 may not allow access to the information stored therein and the terminal 100 may be partially or wholly inoperable.

In addition, if the terminal 100 is determined to be a lost terminal, the terminal 100 may periodically transmit or provide the terminal 100's location information, which may be current at the time the location information is transmitted or provided, to the lost terminal registration server 200. The location information of the lost terminal may be provided according to a reference time interval or according to one or more reference conditions (e.g., set time, when booting up and/or shutting down, and the like).

If the terminal 100 provides the location information of the lost terminal to the lost terminal registration server 200, and if the subscriber authentication module (SIM/USIM) information of the finder is available, the terminal 100 may provide such finder usage history information to the lost terminal registration server 200 along with the location information of the lost terminal.

The lost terminal registration server 200 may store unique terminal information of the lost terminal and contact details registered by the owner of the lost terminal. The unique terminal information, without limitation, may include IMEI, ESN, MAC for the wireless network, a black box, and the like. Registered contact details may include, without limitation, an e-mail address, a chatting address, a Short Message Service (SMS) receiver number, a File Transfer Protocol (FTP) address, and the like.

If the lost terminal registration server 200 receives the location information of the lost terminal and the finder usage history information from the terminal 100, the lost terminal registration server 200 may transmit the received location information of the terminal 100 and the finder usage history information to the owner of the lost terminal. The respective information may be transmitted using the contact details that may be mapped to the unique terminal information of the terminal 100.

That is, if the lost terminal registration server 200 receives the location information of the lost terminal and the finder usage history information from the terminal 100, the lost terminal registration server 200 may transmit the received information to the owner of the lost terminal using one or more available communication services (e.g., an e-mail service, a chatting service, an SMS service, an FTP service, and the like).

For example, in a case where the lost terminal registration server 200 is a server that can provide e-mail service and/or FTP service, the lost terminal registration server 200 may send an e-mail to the owner of the lost terminal or upload a file with relevant information. The e-mail may include location information of the lost terminal and finder usage history information. The e-mail address may be registered in the contact details. In addition, the lost terminal registration server 200 may upload the file with relevant information using the FTP service, which may include the location information of the lost terminal and the finder usage history information. The file may be uploaded to the FTP address that may be registered in the contact details.

In a case where the lost terminal registration server 200 is able to provide a chatting service and/or an SMS service, the lost terminal registration server 200 may transmit the location information of the lost terminal and the finder usage history information to the owner of the lost terminal through the chatting service and/or the SMS service. In an example, the chatting identification (ID) and/or chatting address may be registered in the contact details. Further, an SMS message including the location information of the lost terminal and the finder usage history information to the owner of the lost terminal may be transmitted to the user using the SMS receiver number registered in the contact details.

The lost terminal registration server 200 may be implemented as a dedicated server, or as an arbitrary server registered in a network, such as an e-mail server, a communication service provider server, an SMS server, a chatting server, a location registration server, or a personal server.

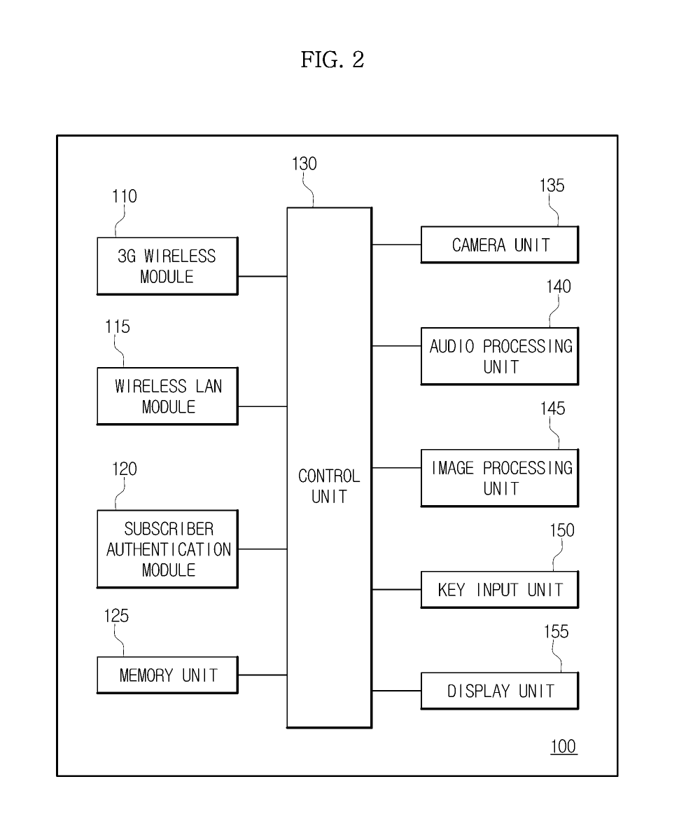

FIG. 2 is a schematic diagram illustrating a terminal to determine the terminal's lost status using a wireless network according to an exemplary embodiment of the invention. This embodiment can be applied to a terminal having a wireless LAN module. FIG. 2 will be described with reference to a 3G terminal having the wireless LAN module as an example.

As shown in FIG. 2, the terminal 100 includes a 3G wireless module 110, a wireless LAN module 115, a subscriber authentication module 120, a memory unit 125, a control unit 130, a camera unit 135, an audio processing unit 140, an image processing unit 145, a key input unit 150, and a display unit 155.

Referring to FIG. 2, the 3G wireless module 110 may transmit and receive a signal to and from a 3G connection network.

The wireless LAN module 115 may transmit and receive a signal to and from a wireless network.

The subscriber authentication module 120, may manage information of subscribers who may subscribe to a 3G communication network. In addition, the subscriber authentication module 120 may store authentication values including algorithms associated with subscriber information and subscriber authentication. In an example, the subscriber authentication module 120 may include, without limitation, a SIM/USIM card.

The memory unit 125 may store Uniform Resource Locator (URL) information of the lost terminal registration server 200 that the terminal 100 connects to. In an example, the lost terminal registration server 200 and the terminal 100 may connect using the wireless network under the control of the control unit 130. If booting is completed in a state where the subscriber authentication module 120 is not mounted or installed in the terminal 100, the terminal 100 may connect to the lost registration server 200 using the stored URL information.

The URL information of the lost terminal registration server 200 stored in the memory unit 125 may be changed by a terminal user or an authorized third party. For example, if the terminal user wants to use his/her personal server as the lost terminal registration server 200, URL information of the personal server may be registered as the URL information of the lost terminal registration server 200. In addition, if the owner of the lost terminal registration server 200 modifies the terminal's URL information, the modified URL information may be transmitted from the lost terminal registration server 200 to the affected terminals.

The control unit 130 may determine whether the subscriber authentication module 120 is mounted or installed in the terminal 100. If booting is completed and the subscriber authentication module 120 is determined not to be mounted or installed in the terminal 100, the control unit 130 may execute the wireless LAN module 115 to connect to the lost terminal registration server 200 using a wireless network. The control unit 130 may then determine whether the terminal is registered as a lost terminal in the lost terminal registration server 200. Although the control unit 130 is disclosed as connecting to the lost terminal registration server 200 using the wireless network in the absence of the authentication module 120, the control unit 130 may connect to the lost terminal registration server 200 even in the presence of the authentication module 120.

Further, the control unit 130 may execute the wireless LAN module 115 in the background so that the finder of the terminal 100 may be unaware of the execution of the wireless LAN module 115.

After executing the wireless LAN module 115, the control unit 130 may periodically attempt to connect to an access point (AP) in order to connect to the wireless network. The control unit 130 may retrieve one or more APs to which the control unit 130 successfully connected before or an open AP using an AP list (i.e., wireless network connection history displayed on the terminal), a black box (i.e., Service Set Identifier (SSID) and/or the like. In addition, the control unit 130 may also retrieve relevant passwords in the event the AP is not an open AP. If the control unit 130 is unable to retrieve a previously connected AP, the control unit 130 may retrieve one or more open APs to connect to.

In an example, one or more APs to which the terminal successfully connected previously may be stored in the black box. In a case where an AP to which the control unit 130 successfully connected before is available, the control unit 130 may attempt to connect to the available AP. In a case where an AP to which the control unit 130 successfully connected previously does not exist, the control unit 130 may attempt to connect to an open AP. Further, the control unit 130 may connect to whichever AP may be available without regard whether the AP is a previously connected AP or an open AP.

If the wireless network connection fails after the control unit 130 attempts to connect to the wireless network, the control unit 130 may deactivate the wireless LAN module 115 to save power. After a reference period of time, the control unit 130 may execute the wireless LAN module 115 again to connect to the wireless network. The control unit 130 may attempt to connect to the wireless network for a reference number of tries at reference time intervals or according to one or more conditions.

If the wireless LAN module 115 is executed by the finder instead of the control unit 130 and connected to the wireless network, the control unit 130 may automatically connect to the lost terminal registration server 200 to determine whether the terminal 100 is registered as a lost terminal in the lost terminal registration server 200.

If the terminal is determined to be registered as a lost terminal in the lost terminal registration server 200, the control unit 130 may back up unique terminal information, so that the control unit 130 may determine the unique terminal information using the back-up data even if the finder arbitrarily changes the unique terminal information. In an example, the unique terminal information, without limitation, may include IMEI, ESN, MAC for the wireless network, a black box and the like.

If the terminal is determined to be registered as a lost terminal in the lost terminal registration server 200, the control unit 130 may activate a locking operation to limit unauthorized access or illegal use of the lost terminal 100 by the finder.

In addition, if the terminal is determined to be registered as a lost terminal in the lost terminal registration server 200, the control unit 130 may periodically provide location information of the lost terminal to the lost terminal registration server 200. The control unit 130 may be connected to the lost terminal registration server 200 using a wireless network.

Further, if the control unit 130 has SIM/USIM information of the finder, the control unit 130 may provide the SIM/USIM information of the finder to the lost terminal registration server 200 along with the location information of the lost terminal. In an example, SIM/USIM information of the finder may be obtained if the finder inserts his or her SIM/USIM card into the lost terminal and registers the SIM/USIM information in the communication service provider network.

Even if the terminal is determined not to be registered as a lost terminal in the lost terminal registration server 200, the control unit 130 may periodically attempt to connect to the lost terminal registration server 200 to determine whether the terminal is registered as a lost terminal in the lost terminal registration server 200.

The camera unit 135 may take and/or capture still and moving images. The audio processing unit 140 may process audio signals received in the terminal 100. The image processing unit 145 may process captured or received images that may be stored in the terminal 100. The key input unit 150 may receive user input to control and/or to provide information to the terminal 100. The key input unit 150 may include, without limitation, a key pad, operation buttons, and the like. In addition, the key input unit 150 may be combined with the display unit 155 as a touchscreen display. The display unit 155 may display captured images, processes, user interface, user input information, various texts and symbols and the like to a user viewing the display unit 155.

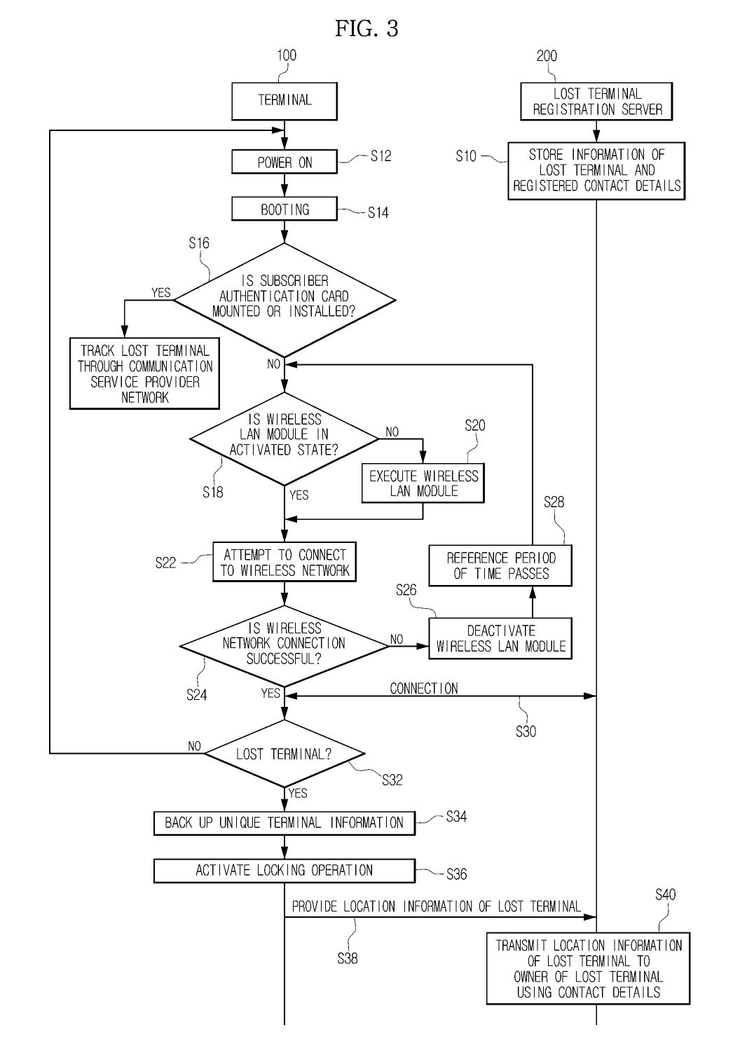

FIG. 3 is a process diagram of a method for securing a lost terminal using a wireless network according to an exemplary embodiment of the invention.

The lost terminal registration server 200 stores terminal information of the lost terminal and contact details, which may be registered by the owner of the lost terminal (S10). In addition, part or all of the terminal information and contact details may also be provided by a third party, such as a wireless communication service carrier (e.g., Sprint®, Verizon®, and the like), a device manufacturer (e.g., Pantech®, Motorola®, and the like), a financial institution, or the like. The unique terminal information, without limitation, may include IMEI, ESN, MAC for the wireless network, a black box, and the like. Registered contact details may include, without limitation, an e-mail address, a chatting address, an SMS receiver number, an FTP address, and the like.

In operation S12, power is applied to the terminal 100 and the terminal 100 is booted in operation S14. In operation S16, the terminal 100 determines whether the subscriber authentication module 120 is mounted or installed in the terminal 100. Although FIG. 3 illustrates the terminal 100 as being initially without power, the described operations may be applied to the terminal 100 that is already powered on.

If the terminal 100 determines that the subscriber authentication module 120 is mounted or installed in the terminal 100, the lost terminal 100 may be tracked using the communication service provider network.

If the subscriber authentication module 120 is determined to be absent or not mounted on the terminal 100 (S16), the control unit 130 determines whether the wireless LAN module 115 is in an activated state (S18). If the wireless LAN module 115 is determined to be in an inactive state, the control unit 130 executes the wireless LAN module 115 (S20) and attempts to connect to a wireless network (S22). If the wireless LAN module 115 is in an active state (S18), the control unit 130 attempts to connect to the wireless network (S22).

If the wireless LAN module 115 is executed in operation S20, the wireless LAN module 115 may be executed in the background. Accordingly, the finder or possessor of the terminal 100 may be unaware of the execution of the wireless LAN module 115.

If an AP to which the terminal 100 successfully connected before is available in the AP list or in the black box, the terminal 100 may attempt to connect to the wireless network using the available AP (S22). If the AP to which the terminal 100 successfully connected before is not available, the terminal 100 attempt to connect to an open AP (S22).

If the wireless network connection fails in operation S24, the wireless LAN module 115 is deactivated to save power (S26) and waits for a predetermined or reference period time to pass before the wireless LAN module 115 is executed again to attempt to connect to the wireless network (S28). This procedure may be repeated until the wireless network connection is successful.

If the wireless network connection is successful, the terminal 100 connects to the lost terminal registration server 200 (S30). In an example, the terminal 100 may connect to the lost terminal registration server 200 using the wireless network according to the URL information of the lost terminal registration server 200 stored in the memory unit 125.

In operation 32, the terminal 100 determines whether the terminal 100 is registered as a lost terminal in the lost terminal registration server 200.

If the terminal 100 is determined not to be registered as a lost terminal in the lost terminal registration server 200 (S32), the terminal 100 may periodically attempt to connect to the lost terminal registration server 200 to determine whether the terminal is registered as a lost terminal in the lost terminal registration server 200.

If the terminal 100 is determined to be registered as a lost terminal in the lost terminal registration server 200 (S32), the terminal 100 backs up unique terminal information so that the control unit 130 may determine the unique terminal information using the backed-up data even if the finder arbitrarily changes the unique terminal information (S34). In an example, the unique terminal information, without limitation, may include IMEI, ESN, MAC for the wireless network, a black box, and the like.

In addition, the terminal 100 activates the locking operation to limit or prevent unauthorized access or illegal use of the terminal 100 by the finder (S36).

In operation 38, the terminal 100 periodically provides location information of the lost terminal to the lost terminal registration server 200 to allow the owner of the lost terminal to track the lost terminal (S38).

Further, in operation S38, if SIM/USIM information of the finder is available, the terminal 100 may provide the SIM/USIM information of the finder to the lost terminal registration server 200 along with the location information of the lost terminal. In an example, SIM/USIM information of the finder may be obtained if the finder inserts his or her SIM/USIM card into the lost terminal and registers the SIM/USIM information in the communication service provider network.

The lost terminal registration server 200, which receives the location information of the lost terminal in operation S38, transmits the location information of the lost terminal to the owner of the lost terminal. In an example, the lost terminal may transmit its location information using the contact details (S40), which may be registered by the owner of the lost terminal and stored in the operation S10. That is, the lost terminal registration server 200 transmits the location information of the lost terminal to the owner of the lost terminal using one or more services (e.g., e-mail service, chatting service, SMS service, FTP service, and the like) registered by the owner of the lost terminal.

According to aspects of the invention, the terminal may execute the wireless LAN module if the subscriber authentication module is absent from the terminal, connect to the lost terminal registration server using the wireless network, determines whether the terminal is a lost terminal, and limit the use of the terminal, thereby limiting the illegal use or unauthorized access of the lost terminal by a finder.

In addition, information related to the terminal that may be used to recover the terminal may be collected and transmitted to the owner of the lost terminal so that a recovery rate of the lost terminals can be increased.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A system to secure a lost terminal using a wireless network, the system comprising:
a lost terminal registration server to store unique terminal information of a lost terminal; and
a terminal comprising a wireless Local Area Network (LAN) module to execute the wireless LAN module, to connect to the lost terminal registration server using the wireless network, and to determine whether the terminal is registered as a lost terminal in the lost terminal registration server.

2. The system claim 1, wherein the unique terminal information comprises at least one of an International Mobile Equipment Identity (IMEI), Electronic Serial Number (ESN), and Media Access Control (MAC) for the wireless network.

3. The system of claim 1, wherein the unique terminal information is registered by an owner of the lost terminal.

4. The system of claim 1, wherein the lost terminal registration server further stores contact details of the lost terminal, receives location information of the lost terminal, and transmits the location information of the lost terminal using the contact details.

5. The system of claim 4, wherein the contact details are registered by an owner of the lost terminal.

6. The system of claim 4, wherein the contact details comprise at least one of an e-mail address, a chatting address, a Short Message Service (SMS) receiver number, a recipient phone number, and a file transfer protocol (FTP) address.

7. The terminal of claim 1, wherein the terminal activates a locking operation if the terminal is determined to be a lost terminal.

8. A terminal, comprising:
a wireless Local Area Network (LAN) module to transmit and receive a signal to and from a wireless network; and
a control unit to execute the wireless LAN module to connect to a lost terminal registration server using the wireless network, and to determine whether the terminal is registered as a lost terminal in the lost terminal registration server.

9. The terminal of claim 8, wherein the control unit further determines whether a subscriber authentication module is installed in the terminal.

10. The terminal of claim 8, wherein the control unit executes the wireless LAN module in the background.

11. The terminal of claim 8, wherein the control unit backs up unique terminal information.

12. The terminal of claim 11, wherein the unique terminal information comprises at least one of an International Mobile Equipment Identity (IMEI), Electronic Serial Number (ESN), and Media Access Control (MAC) for the wireless network.

13. The terminal of claim 8, wherein the control unit activates a locking operation if the terminal is determined to be a lost terminal.

14. The terminal of claim 8, wherein the control unit transmits location information of the terminal to the lost terminal registration server if the terminal is determined to be a lost terminal.

15. The terminal of claim 8, wherein if the wireless LAN module is unable to connect to a wireless network, the wireless LAN module is deactivated and re-executed at a reference time interval to connect to the wireless network.

16. A method for securing a lost terminal using a wireless network, the method comprising:
attempting to connect to the wireless network by executing a wireless Local Area Network (LAN) module in a terminal;
connecting to a lost terminal registration server using the wireless network; and
determining whether the terminal is registered as a lost terminal in the lost terminal registration server.

17. The method of claim 16, further comprising determining whether a booting operation of the terminal is completed,
wherein a subscriber authentication module is mounted to the terminal and the terminal boots according to power applied to the terminal.

18. The method of claim 16, further comprising backing up unique terminal information if the terminal is determined to be registered as a lost terminal in the lost terminal registration server.

19. The method of claim 16, further comprising activating a locking operation if the terminal is determined to be registered as a lost terminal in the lost terminal registration server.

20. The method of claim 16, further comprising:
providing location information of the terminal to the lost terminal registration server if the terminal is determined to be registered as a lost terminal in the lost terminal registration server; and
transmitting the location information of the terminal using contact details of the lost terminal from the lost terminal registration server.
